(19) United States
(12) Patent Application Publication
(10) Pub. No.: US 2026/0315972 A1
(43) Pub. Date: Oct. 15, 2026

(54) FILTER AND MANUFACTURING APPARATUS AND METHOD FOR THE SAME

(71) Applicant: A. O. Smith Corporation, Milwaukee, WI (US)

(72) Inventors: Hai-Feng Zhang, Wauwatosa, WI (US); Devin Gareis, Wauwatosa, WI (US); Yilda Torres, Hartland, WI (US)

(21) Appl. No.: 19/481,294

(22) PCT Filed: Jun. 27, 2024
(86) PCT No.: PCT/US2024/035822

§ 371 Date: Nov. 4, 2025

Related U.S. Application Data
(60) Provisional application No. 63/510,814, filed on Jun. 28, 2023.

(51) Int. Cl. B01D 39/20

(52) U.S. Cl. CPC B01D 39/2055; B01D 2239/0407; B01D 2239/0636; B01D 2239/0645; B01D 2239/10

(57) ABSTRACT

A method of making a water filter includes creating a slurry mixture comprising a liquid, at least one fiber material, and powder. A filter body is built from the slurry while simultaneously removing at least a portion of the liquid from the slurry. The filter body is cured using heat to form a filter block. The powder can include activated carbon with a particle size that is in the range of 45 μm to 180 μm, and can include at least one additive to remove a contaminant.

### CROSS-REFERENCE TO RELATED APPLICATIONS

This application claims priority to U.S. provisional patent application No. 63/510,814, filed on Jun. 28, 2023, the entire contents of which are hereby incorporated by reference in their entirety.

### BACKGROUND

Water filters constructed using activated carbon are capable of removing undesirable chemicals, disinfection byproducts for example, from drinking water. One common type of such filters is made by housing granular activated carbon (GAC) within a container. While cost-effective, such filter have generally low performance, and must be of a large size or must be replaced frequently. Another type of such filter is a carbon block filter, made by extruding or compression molding carbon powder with a binder. Such carbon block filters have somewhat better performance, but can suffer from increased cost and undesirably high pressure drop, and are difficult to make in larger sizes.

Carbon block filters have the benefit of being formed via a one-step process (molding or extrusion). Additives can be added into the carbon block filter to increase the functionality of the filter. However, forming a carbon block filter having both a low pressure-drop and high performance is limited by the brittleness of the carbon block filter. The brittleness of the carbon block filter also makes it difficult to produce larger filters. In contrast to carbon block filters, composite paper type filters can have multiple functions with a low pressure drop, increased performance and the potential for a longer lifetime. However, a drawback of the composite paper type filters is that the manufacturing process is a two-step process: first making the composite filter papers, and then rolling the filter papers into filters. Furthermore, there are limitations in improving the performance of composite paper type filters, as the amount of carbon that can be added to such filter is limited by the need to maintain flexibility in the paper material for rolling.

There is therefore a need to produce multi-functional high-performance filters that realize a decreased pressure drop and improved contaminant removal. Furthermore, there is a need for a method that allows for cost-effective production of larger size filters to address higher water flow rate applications.

### SUMMARY

The present disclosure relates to a method of making a water filter. The method of making a water filter includes creating a slurry mixture comprising a liquid, at least one fiber material, and powder. A filter body is built from the slurry while simultaneously removing at least a portion of the liquid from the slurry. The filter body is cured using heat to form a filter block. In at least some embodiments, the powder includes activated carbon, and in some such embodiments at least 90% by weight of the activated carbon has a particle size that is in the range of 45 μm to 180 μm.

In some embodiments, the powder includes at least one additive. In some such embodiments, the at least one additive includes a Heavy Metal Removal Power (HMRP). In some such embodiments, the at least one additive includes Activated Teff Straw (ATF). In some such embodiments, the at least one additive includes Kinetic Degradation Fluxion (KDF) material. In some embodiments, combinations of two or more of the above are provided as additives. In at least some embodiments, at least 50% by weight of an additive has a particle size between 20 μm to 50 μm.

In some embodiments, the fiber material includes activated carbon fiber (ACF). In some embodiments, the fiber material includes glass fiber. In some embodiments, the fiber material includes Polyethylene Terephthalate (PET). In some embodiments, the fiber material includes cellulose. In some embodiments, the fiber material includes acrylic. In some embodiments, the fiber material includes two or more of the above. In some embodiments, the fiber includes at least two fiber materials. In some such embodiments, the fibers of a first fiber material have lengths in a range of 1-10 μm and the fibers of the second fiber material have lengths in a range of 3-5 mm. Some particular embodiments have 2-10% by weight of the fiber consisting of PET fibers having lengths of 3-5 mm.

In some embodiments, the slurry is at least 90% liquid by weight after the slurry mixture is created. In some embodiments, the portion of the liquid removed while building the filter body is removed by a centrifugal force or a compressive force or both. In some embodiments, the filter body is dried to remove a remaining portion of the liquid prior to curing the filter body.

Some embodiments include building the filter body by rotating a liquid-permeable hollow cylindrical structure about a central axis, dispensing the slurry mixture within an internal volume of the hollow cylindrical structure, and building from the slurry a filter body upon the hollow cylindrical structure in a radially inward direction. In such embodiments, the portion of the liquid can be removed from the filter body through the liquid-permeable hollow cylindrical structure by way of centrifugal force caused by rotating the structure about the central axis. In some such embodiments, dispensing the slurry mixture can include delivering the slurry mixture into a hollow tube arranged approximately along the central axis and translating the hollow tube parallel to the central axis such that an opening of the hollow tube repeatedly traverses between a first and a second end of the hollow cylindrical structure. The opening can, in some embodiments, traverse between the first end and the second end at a rate of 1-20 cycles per minute. The liquid-permeable hollow cylindrical structure can, ins some embodiments, rotate at a rate of 1000-2500 revolutions per minute.

In at least some embodiments, a first portion of liquid is removed from the slurry prior to the step of building the filter body, and a second portion of liquid is removed from the slurry while building the filter body. The slurry can have a first liquid content after the slurry mixture is created and a second liquid content after removing the first portion of the liquid from the slurry. In some embodiments, the second liquid content is between 10% and 30% of the first liquid content.

In some embodiments, the first portion of liquid is removed from the slurry by placing the slurry in contact with a liquid-permeable membrane, applying a negative pressure gradient across the liquid-permeable membrane, and driving the first portion of liquid through the liquid-permeable membrane using the negative pressure gradient. In some embodiments, building the filter body includes placing the slurry into a mold having one or more orifices arranged at at least one end of the mold, and applying a compressive load to the slurry in order to drive the second portion of the liquid from the slurry through the one or more orifices.

### BRIEF DESCRIPTION OF THE DRAWINGS

FIG. 1 is a flowchart detailing a method of making a water filter according to one embodiment.

FIG. 2 is a schematic front view of an apparatus used in some embodiments of the method of FIG. 1.

FIG. 3 is an enlarged front view of a liquid-permeable hollow cylindrical structure of the apparatus of FIG. 2.

FIG. 4 is a schematic side view of the apparatus of FIG. 2.

FIG. 5 an enlarged front view of a hollow tube that provides a slurry mixture to the hollow cylindrical structure of FIG. 3.

FIG. 6 is a schematic side view of the hollow tube providing the slurry mixture to the hollow cylindrical structure.

FIG. 7 is a flowchart detailing a method of making a water filter according to another embodiment.

FIG. 8 is a schematic front view of an apparatus used in some embodiments of the method of FIG. 7.

FIG. 9 is a bottom view of an apparatus used in some embodiments of the method of FIG. 7.

FIG. 10 is a cross-sectional side view of the apparatus of FIG. 9, as viewed along the lines X-X of FIG. 9.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting, and coupling.

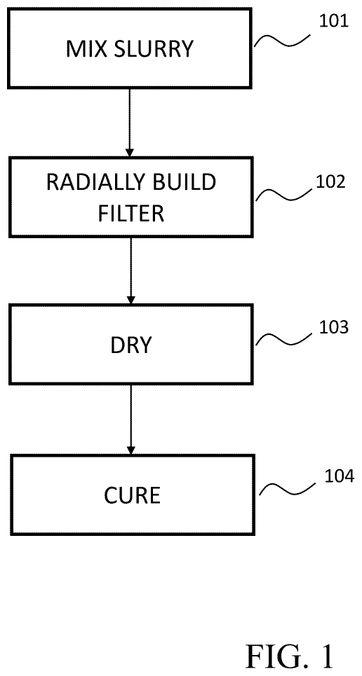

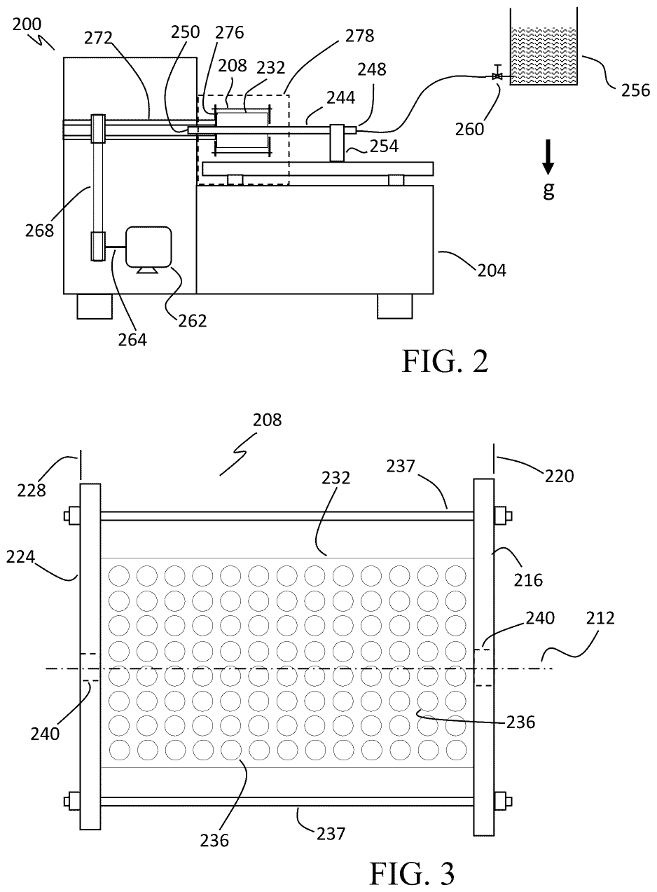

FIG. 1 illustrates a method of making a water filter with FIGS. 2-6 illustrating one embodiment of an apparatus for carrying out the method illustrated in FIG. 1. The method of making a water filter according to FIG. 1 is a wet process for filter making that includes forming a slurry, radially building a filter from the slurry, drying the filter, and curing the filter.

At a first step 101 of the method, a slurry is formed. The slurry includes one or more powders, one or more fibers, and a liquid material. The powder can include activated carbon and, in different embodiments, includes additional additives to provide various different functions, as desired. For example, heavy metal removal powder (HMRP) and/or activated teff straw (ATF) may be incorporated as additives where heavy metal reduction is desired. Further, other additives such as kinetic degradation fluxion (KDF) media may be incorporated where a reduction in chlorine, lead, mercury, iron, and/or hydrogen sulfide is desired. Other additives may be further included to reduce contaminants such as heavy metals, chlorine, and bacteria.

The particle size of the activated carbon powder is less than 200 μm and in some embodiments is as small as 20 μm (e.g., between 20 μm-200 μm, at least 20 μm). In one embodiment, at least 90% of the activated carbon powder has a particle size between 44 μm and 177 μm. The particle size of the additives is dependent upon the particular additive and may be similar to the particle size of the activated carbon. In some embodiments, the particle size of the additives is between 20 μm and 50 μm.

In some embodiments, the fibers incorporated into the slurry include inorganic fibers such as activated carbon fiber (ACF) and/or glass fiber. In other embodiments, the fibers include organic fibers such as polyethylene terephthalate (PET), cellulose, and/or acrylic. The fibers can have varying diameters and lengths. For example, glass fiber can have a diameter between 100 nm-200 nm and an average length of 1-10 μm. Activated carbon fiber can have a diameter between 3-5 μm (or larger) with an average length between 0.1 mm-3.0 mm. PET can have a diameter between 1-5 μm and an average length between 3 mm-5 mm. In some embodiments, PET is a binding fiber having a core-sheath structure with a core and a sheath having different melting temperatures to bind the structure without damaging the structure. Cellulose can have a diameter as small as 0.1 μm and a length between 2 μm-100 μm. Other fibers not listed herein can have sizes ranging the size of cellulose to the size of PET. Multiple fiber materials may be used simultaneously within the mixture for the slurry. For example, long fibers (e.g., 3 mm-6 mm PET) may be mixed with short fibers at a ratio of 5-25:1 (e.g., 5:1, 10:1, 15:1, 20:1) by weight.

The powder(s) and fiber(s) are added to the liquid, which, in some embodiments, is water. The weight ratio of powder to fiber can, in some exemplary embodiments, be between 2:1 and 10:1. The ratio of solids to liquids is between 1:100 and 10:100 by weight (i.e., 10-100 times more liquid than solid) to facilitate sufficient flow during the filter building process. In some particular embodiments, the ratio of solids to liquids is in the range of 1:10 to 1:50 by weight (e.g., 1:10, 1:20, 1:50, etc.). The materials are mixed together and homogenized via a mixer (e.g., a high shear rotary mixer) to form the slurry. In some embodiments, the solids are mixed with the liquids via rotation of rotor blades of the mixer at speeds between 1000 RPM-6000 RPM.

At a second step 102 of the method, a filter is built from the slurry. FIGS. 2-6 illustrate an apparatus 200 for forming the filter from the slurry. With reference to FIG. 2, the apparatus 200 includes a base 204 that rests upon a flat surface (e.g., a ground surface, a tabletop surface). The base 204 supports a liquid-permeable hollow cylindrical structure 208 within which the filter is formed. The hollow cylindrical structure 208 is rotatably mounted to the base 200 such that the hollow cylindrical structure 208 is configured to rotate about a rotational axis 212. The hollow cylindrical structure 208 is generally cylindrical and has a central axis that is coaxial with the rotational axis 212. The hollow cylindrical structure 208 is mounted to the base 204 such that the rotational axis 212 extends generally parallel with the flat surface upon which the apparatus 200 rests. The hollow cylindrical structure 208 is shown in greater detail in FIG. 3.

As shown in FIG. 3, the hollow cylindrical structure 208 includes a first end plate 216 at a first axial extent 220 of the hollow cylindrical structure 208, a second end plate 224 at a second axial extent 228 (opposite the first axial extent 220), and a liquid permeable cylinder 232 extending between the two end plates 216, 224. In some embodiments, the liquid permeable cylinder 232 is a mesh tube and may be formed as a porous polymer tubing or as stainless-steel mesh. Optionally, a woven sheet or a non-woven porous paper or mat may be positioned within the liquid permeable cylinder 232 to prevent solid material loss through the openings 236 of the liquid permeable cylinder 232. In some embodiments, the openings 236 in the mesh tube 232 are between 0.5 mm and 2.0 mm in diameter (or width if non-circular) with the openings 236 covering between 20% and 70% of the surface of the liquid permeable cylinder 232. The inner diameter of the liquid permeable cylinder 232 corresponds to the desired outer diameter of the finished filter formed therein. Accordingly, filters having different outer diameters can be formed by utilizing cylinders 232 of different inner diameters. In some embodiments, the inner diameter of the cylinder 232 may be as small as 10 mm. In other embodiments, the inner diameter of the cylinder 232 may be 25 mm-100 mm. Still other embodiments may utilize a cylinder 232 having an inner diameter larger than those, including a diameter of 250 mm or greater.

In addition to the liquid permeable cylinder 232, a plurality of support rods 237 extend between the two end plates 224 to secure the second end plate 224 to the first end plate 220. The support rods 237 are located radially outward of the liquid permeable cylinder 232 so as to not interfere with the filter forming process within the cylinder 232. In some embodiments, the support rods 237 are formed as threaded rods held in place via nuts threaded thereon. The support rods 237 are preferably arranged at a constant angular spacing around the rotational axis 212, such as (for example) at 90°, 60°, 45°, etc.

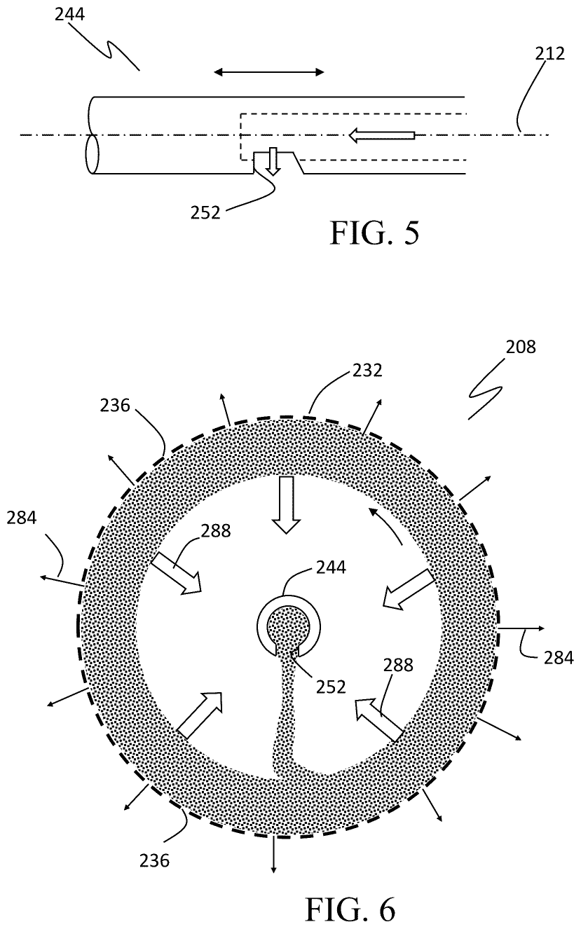

Each end plate 216, 224 (or in some embodiments, only the second end plate 224) includes a central opening 240 centered on the rotational axis 212. With the exception of the central openings 240, the end plates 216, 224 are substantially liquid impermeable to prevent liquids and solids from passing therethrough during the filter making process. A delivery tube 244 extends through the central openings 240 to deliver the slurry into the hollow cylindrical structure 208. As shown in FIG. 2, the delivery tube 244 is mounted to the base 204 and includes an inlet 248 at a first end, and an opening or outlet 252 (FIG. 5) within the hollow cylindrical structure 208. As a second end 250 (opposite the inlet end 248) of the delivery tube 244 extends through the opening 240 of the first end plate 216, the outlet 252 is located between the ends of the delivery tube 244. As shown in greater detail in FIG. 5, the outlet 252 is preferably located on a lower side (underside) of the delivery tube 244 such that gravity assists in delivering the slurry from the tube 244 into the liquid permeable cylinder 232. In other embodiments where only the second plate 224 includes a central opening, the second end of the delivery tube 244 may terminate within the hollow cylindrical structure 208 with the outlet formed at the second end.

The delivery tube 244 is hollow at least between the inlet 248 and the outlet 252, such that the slurry is configured to enter the inlet 248 of the delivery tube 244 and exit the delivery tube 244 via the outlet 252. The inner diameter of the delivery tube 244 may be between 0.5″ and 3″ (and may be larger, for producing larger filter sizes). In some embodiments, such as larger-scale apparatuses 200, multiple delivery tubes 244 may be utilized simultaneously. The inlet 248 is coupled to a slurry tank 256 that holds the slurry, with the slurry fed from the slurry tank 256 to the delivery tube 244 via a pump or via a gravity feed (i.e., the outlet of the slurry tank 256 being positioned above the outlet 252 of the delivery tube 244). In other embodiments, other methods may be utilized to move the slurry out of the slurry tank, such as a hydraulic cylinder. A mixer may be positioned within the slurry tank 256 to continually mix the slurry within the slurry tank 256, even during operation of the apparatus 100. A valve 260 can be positioned between the slurry tank 256 and the outlet 252 of the delivery tube 244 (i.e., between the slurry tank 256 and the inlet 248 of the delivery tube 244 or between the inlet 248 of the delivery tube 244 and the outlet 252 of the delivery tube 244) to control the flow from the slurry tank 256. In some embodiments, the valve 260 is manually actuated. In other embodiments, the valve 260 is actuated electronically, hydraulically, or a combination of the same, based on a signal (e.g., from a controller).

The delivery tube 244 is mounted to a support 254 (and optionally a further support, such as within the output shaft 272) that permits axial translation of the delivery tube 244 relative to the base 204 and relative to the hollow cylindrical structure 208. As such, the outlet 252 is configured to translate along the length of the mesh tube 232 between the two end plates 216, 224 to facilitate delivery of the slurry along the entire length of the mesh tube 232. In some embodiments, the delivery tube is configured to travel such that the outlet 252 translates between the two axial extents at a rate of 1-20 cycles per minute (a cycle being defined as translating from a first end to a second end and then back to the first end). In some embodiments, the delivery tube 244 is moved manually by an operator. In other embodiments, the delivery tube is moved electrically or hydraulically (e.g., by a motor, linear actuator, lead screw, etc.) and is controlled via a controller to move at a predetermined rate.

The base 204 of the apparatus 200 includes a motor 262 for imparting rotation to the hollow cylindrical structure 208. The motor 262 includes a motor shaft 264 that rotates the hollow cylindrical structure 208, either directly or indirectly (e.g., through a belt and pully or gear arrangement 268). As shown in FIG. 2, the motor shaft 264 can indirectly drive the hollow cylindrical structure 208 through a separate output shaft 272 that is coupled to the hollow cylindrical structure 208 for rotating with the hollow cylindrical structure 208. In some embodiments, the output shaft 272 and hollow cylindrical structure 208 rotate at 1000-2500 revolutions per minute. In other embodiments, the speeds may be still greater than 2500 revolutions per minute. The end plate 224 includes a mounting structure 276 for securing the hollow cylindrical structure 208 to the base 204 while still allowing relative rotation therebetween. In some embodiments, the mounting structure 276 includes fasteners (such as threaded fasteners) for coupling the hollow cylindrical structure 208 to the output shaft 272 (or motor shaft 264, in the case where the motor 262 directly drives the rotation). In other embodiments, the mounting structure 276 may be formed as a chuck on the output shaft 272 that is moved radially to grasp the hollow cylindrical structure 208. In some embodiments, the output shaft 272 is hollow such that the second end 250 of the delivery tube 244 extends into the output shaft 272.

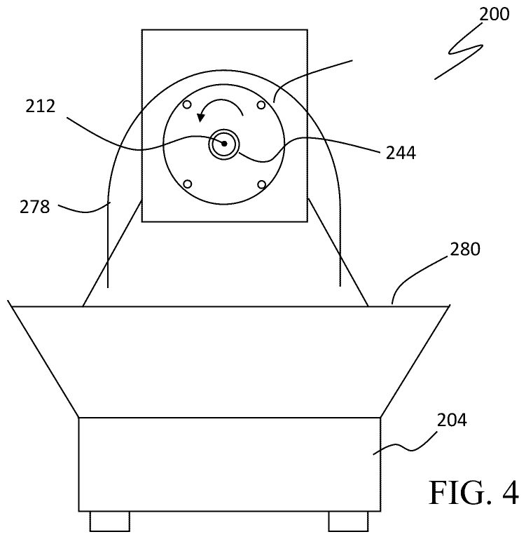

As can be best seen in FIG. 4, the apparatus 200 can include a splash guard 278 that extends substantially around the hollow cylindrical structure 208 to limit the flow of liquid outside the confines of the apparatus 200. Additionally, the apparatus 200 includes a liquid catch basin 280 positioned below the hollow cylindrical structure 208 to catch liquid that flows out through the openings 236 in the mesh tube 232 and to catch liquid that drops downward off of the splash guard 278.

In operation, to radially build a filter, the motor 262 is actuated, thereby rotating the motor shaft 264 and further rotating the output shaft 272 via the belt and pully or gear arrangement 268. As the output shaft 272 rotates, the hollow cylindrical structure 208 likewise rotates about the rotational axis 212. The delivery tube 244 is positioned within the central opening 240 of the end plates 216, 224 so that the outlet 252 of the delivery tube 244 is positioned within the liquid permeable cylinder 232 of the hollow cylindrical structure 208. The delivery tube 244 is actuated, either manually or via electronic or hydraulic control, to translate between first and second extremes, corresponding to the outlet 252 extending to the two axial extents of the liquid permeable cylinder 232. With the hollow cylindrical structure 208 rotating and the delivery tube 244 translating, the slurry is provided from the slurry tank 256 to the delivery tube. Providing the slurry from the slurry tank 256 can include opening the valve 260 and can further include operating a pump (or otherwise allowing the flow to exit the tank 256, e.g. via gravity) to deliver the slurry to the delivery tube 244. The slurry enters the inlet 248 of the delivery tube 244 and exits through the outlet 252 into the liquid permeable cylinder 232 of the hollow cylindrical structure. The slurry builds up on the cylinder 232 with centrifugal forces pushing the liquid portion (e.g., water) of the slurry through the openings 236 (as shown by arrows 284 on FIG. 6). The powder and fiber of the slurry build up on the cylinder 232, progressively building further inward (as shown by arrows 288 on FIG. 6) as the slurry continues to pour in from the outlet 252. When the amount of slurry has built up to a desired thickness within the cylinder 232 (i.e., a desired thickness of the filter), the valve 260 is closed and (if used) the pump is deactivated to prevent providing further slurry to the delivery tube 244. The actuation of the delivery tube 244 and operation of the motor 262 are likewise deactivated to halt translation of the delivery tube 244 and rotation of the hollow cylindrical structure. The slurry (with much of the liquid removed via operation of the apparatus 100) within the cylinder 232 represents a built filter with post processing steps of drying (step 103) and curing (step 104) resulting in a finished filter. In some preferable embodiments, at least 90% of the original liquid content of the slurry has been removed in step 102, and up to 95% of the original liquid content has been removed in step 102 in particularly preferable embodiments.

Following formation of the filter via the apparatus, the filter is dried at step 103. In some embodiments, the built filter and cylinder 232 are removed together. In other embodiments, the built filter may be removed from the cylinder prior to drying. The drying process removes any remaining water that was not removed during the formation of the filter.

Following drying, the filter is cured at step 104. Curing includes further heating to fuse the fibers of the filter body together, resulting in a finished filter. By way of example, the curing can include heating the filter to a temperature that is near, but below, a melting temperature of the binder material, so that individual strands of the binder material fuse together at the conclusion of the curing step 104 (e.g. during a cool-down). Optionally, the drying step 103 and the curing step 104 can be performed in a single combined operation.

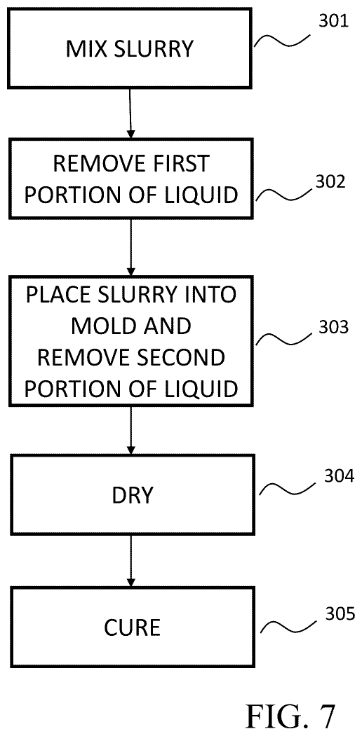

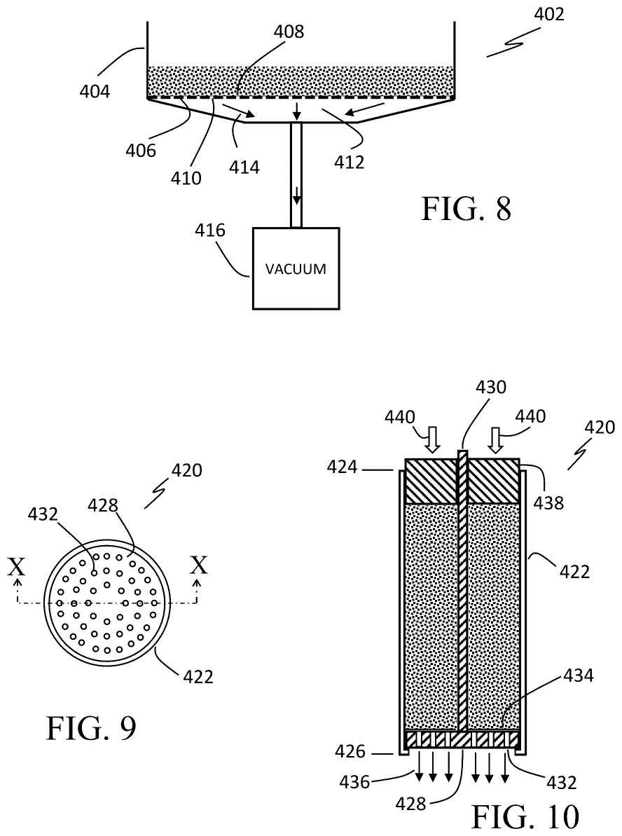

FIG. 7 illustrates another method of making a water filter, with FIGS. 8-10 illustrating apparatus for carrying out the method of FIG. 7 in one embodiment. The method of making a water filter according to FIG. 7 is a wet process for filter making that includes forming a slurry, removing a first portion of liquid from the slurry, forming slurry into a filter shape and removing a second portion of liquid, drying the filter, and curing the filter.

The mixing of the slurry (step 301) can be performed in a like manner to that described previously with reference to step 101 of FIG. 1. Proceeding to step 302, a first portion of the liquid content of the slurry is removed therefrom, resulting in a slurry that is still fluid but is substantially higher in viscosity than the initial slurry. In other words, the slurry has a first liquid content after step 301, and a second liquid content that is less than the first liquid content after step 302. In some embodiments, the slurry has a paste-like consistency after the first portion of liquid has been removed in step 302. In some such embodiments, the first portion of the liquid is in the range of 70-90% of the original liquid content of the slurry, for example 80%, so that the second liquid content is between 10% and 30% of the first liquid content, for example 20%.

FIG. 2 depicts an apparatus 402 for performing step 302 according to one embodiment. The apparatus 402 includes a troth 404 into which the slurry can be poured or otherwise dispensed. The troth 404 includes a horizontally arranged plate 406 at a bottom end of the troth, with a series of openings 410 arranged thereon. The plate 406 can, for example, be formed of a sheet of perforated plate material, expanded metal plate, etc., and the openings 410 can cover a substantial portion of the total surface of the plate 406. By way of example, the openings 410 can comprise a total open area that is equal to 50% or more, 60% or more, 70% or more, or 80% or more of the total surface area of the plate 406. A liquid-permeable membrane 408, such as a woven sheet or a non-woven porous paper or mat, is arranged on the top surface of the plate 406 to prevent solids of the slurry (for example, the fiber material, powder, and additives) from passing through the openings 410.

A suction device such as a vacuum 416 is in fluid communication with a plenum 412 of the troth 402, the plenum 412 being arranged below the horizontally arranged plate 406. In performing step 302, the slurry is poured or otherwise dispensed into the troth 402 onto the membrane 408, such that the surface of the plate 406 is covered with slurry. The suction device 416 is then engaged to reduce the pressure within the plenum 412 to be below the pressure above the slurry (which can be atmospheric pressure), thereby creating a negative pressure gradient across the liquid-permeable membrane. The negative pressure gradient drives at least a portion of the liquid within the slurry through the liquid-permeable membrane 408 and the openings 410, as indicated by the arrows 414. The solids of the slurry, such as the fiber material, powder, and additives, are not able to pass through the membrane 408 and remain within the slurry.

After step 302 is completed, the slurry is substantially drier but remains in a fluid state and the fiber, powder, and other additives remain well-mixed within the slurry. Proceeding to step 303, the slurry is placed into a mold in order to both remove a second portion of water from the slurry and form the slurry into a filter body having the desired filter shape. FIGS. 9-10 depict a mold 420 that, in some embodiments, can serve as an apparatus for performing step 303.

The mold 410 includes an outer sleeve 422 which has an inner surface that corresponds to the desired outer profile of the completed water filter body. In the exemplary embodiment of FIGS. 9-10, the outer sleeve 422 has a cylindrical shape, but it should be understood that other geometries can be used to form filter bodies having different shapes. A bottom pressure plate 428 is arranged at a bottom end 426 of the outer sleeve 422. Orifices 432 are arranged over the surface of the bottom pressure plate 428 and extend through the bottom pressure plate 428. A central rod 430 extends upwardly into an inner volume of the sleeve 422 from the bottom pressure plate 428, and is shaped and sized to define an inner surface of the filter body.

In performing step 303, a liquid-permeable membrane 434, such as a woven sheet or a non-woven porous paper or mat, is placed into the inner cavity of the sleeve 422 and rests upon the bottom pressure plate 428. A central opening is provided in the membrane 434 to accommodate the central rod 430. The membrane 434 covers the apertures 432, so that at least the solid portions of the slurry placed within the mold 420 are prevented from passing through the orifices 432. A desired amount of the slurry is subsequently introduced into the inner cavity of the sleeve 422 from a top end 424 of the sleeve to form the water filter. Once the desired amount of slurry is present within the inner cavity, a top pressure plate 438 is placed on top of the slurry and at least partially within the inner cavity, and a compressive force (indicated by the arrows 440) is applied to the top pressure plate 438 in order to compress the slurry between the plates 438 and 428. As a result of the compression, a second portion of liquid (indicated by arrows 436) is driven from the slurry through the liquid-permeable membrane 434 and the orifices 432. At the end of step 303, only a small percentage of the original fluid content of the slurry remains within the mold, preferably no more than 10% of the original fluid content, and even more preferably not more than 5% of the original fluid content.

Through application of the compressive force 440, the slurry can be compressed such that the overall height of the slurry within the mold 420 (i.e. the distance between the inwardly facing surfaces of the pressure plates 428, 438) corresponds to a desired height of the water filter body. The position of the top pressure plate 438 can then be locked, relative to the outer sleeve 422 and the bottom pressure plate 428, in order to maintain that spacing. The mold 420 is placed within an oven to dry out any remaining portion of the liquid from the filter body (step 304).

After drying, the filter body is cured (step 305) in a similar fashion to that described with respect to step 104. The curing step can be performed while the filter body is still within the mold 420. Alternatively, the filter body may be sufficiently solid after the drying step 304 that it can be removed from the mold 420 for the curing step. Optionally, the drying step 304 and the curing step 305 can be performed in a single combined operation.

A filter formed by the processes described above can result in a decreased pressure drop with 50%-100% greater capacity than a conventional carbon block filter of the same size.

Additionally, the processes allow for increased flexibility in including additives to address specific contaminants. Mixing the additives into a liquid slurry results in a more even distribution of the additives as compared to a dry mixture. Additionally, the processes described above can allow for larger filters to be produced than in a traditional sintered carbon block filter process.

As one non-limiting example, a filter constructed according to the method of FIG. 1 was made using short fibers (having nanometer-range diameters and 5-100 μm lengths), long fibers (2 denier diameter and 3-6 mm lengths), and 80×325 mesh size activated carbon, with a weight ratio of 15:1:135 (short fibers: long fibers: carbon), or a powder: fiber weight ratio of approximately 8.4:1. The filter was constructed to an outer diameter of 106 mm, an internal diameter of 84 mm, and a length of 223 mm. This filter was tested to NSF53 testing standards for volatile organic chemical (VOC) removal, using chloroform as the test contaminant, and showed a test capacity of 8300 liters of water treated, with an end-of-test pressure drop of 2-3 psi.

As another non-limiting example, a filter constructed according to the method of FIG. 7 was made using the same short fibers, long fibers, and activated carbon, and with HRMP material added for lead removal, with a weight ratio of 17:2:37:28 (short fibers: long fibers: carbon: HRMP), or a powder: fiber weight ratio of approximately 3.4:1. The filter was constructed to an outer diameter of 50 mm, an internal diameter of 10 mm, and a length of 125 mm. This filter was tested for lead removal at an elevated flow rate of 2L/minute, and showed a test capacity of 3300 liters of water treated, with an end-of-test pressure drop of 30 psi.

What is claimed is:

1. A method of making a water filter, comprising:
creating a slurry mixture comprising a liquid, at least one fiber material, and powder comprising activated carbon;
building a filter body from the slurry while simultaneously removing at least a portion of the liquid from the slurry; and
curing the filter body using heat to form a filter block.

2. The method of claim 1, wherein at least 90% by weight of the activated carbon has a particle size between 45 μm and 180 μm.

3. The method of claim 1, wherein the powder further comprises at least one additive selected from a group consisting of a Heavy Metal Removal Powder (HMRP), Activated Teff Straw (ATF), and a Kinetic Degradation Fluxion (KDF) material.

4. The method of claim 3, wherein at least 50% by weight of the at least one additive has a particle size between 20 μm and 50 μm.

5. The method of claim 1, wherein the ratio by weight of powder to fiber is between 2:1 and 10:1.

6. The method of claim 1, wherein the fiber material comprises one or more fiber materials selected from a group consisting of activated carbon fiber (ACF), glass fiber, Polyethylene Terephthalate (PET), cellulose, and acrylic.

7. The method of claim 6, wherein the fiber comprises a first fiber material and a second fiber material and wherein fibers of the first fiber material have lengths in a range of 1-10 μm and fibers of the second fiber material have lengths in a range of 3-5 mm.

8. The method of claim 6, wherein 2-10% by weight of the fiber consists of PET fibers having lengths of 3-5 mm.

9. The method of claim 1, wherein the slurry is at least 90% liquid by weight after the slurry mixture is created.

10. The method of claim 1, further comprising drying the filter body to remove a remaining portion of the liquid prior to curing the filter body.

11. The method of claim 1, wherein said portion of the liquid is removed from the filter body by at least one of a centrifugal force and a compressive force.

12. The method of claim 1, wherein building the filter body comprises:
rotating a liquid-permeable hollow cylindrical structure about a central axis;
dispensing the slurry mixture within an internal volume of the hollow cylindrical structure;
building from the slurry a filter body upon the hollow cylindrical structure in a radially inward direction; and
removing said portion of the liquid from the filter body through the liquid-permeable hollow cylindrical structure by way of centrifugal force caused by rotating the structure about the central axis.

13. The method of claim 12, wherein the step of dispensing the slurry mixture comprises:
delivering the slurry mixture into a hollow tube arranged approximately along the central axis, the hollow tube having at least one opening; and
translating the hollow tube parallel to the central axis such that the at least one opening repeatedly traverses between a first and a second end of the hollow cylindrical structure.

14. The method of claim 13, wherein the at least one opening traverses between the first end and the second end at a rate of 1-20 cycles per minute.

15. The method of claim 12, wherein the liquid-permeable hollow cylindrical structure is rotated at a rate of 1000-2500 revolutions per minute.

16. The method of claim 1, wherein the portion of liquid removed from the slurry while building the filter body is a second portion, further comprising removing a first portion of the liquid from the slurry prior to the step of building the filter body.

17. The method of claim 16, wherein the slurry has a first liquid content after the slurry mixture is created and wherein the slurry has a second liquid content after removing the first portion of liquid from the slurry, wherein the second liquid content is between 10% and 30% of the first liquid content.

18. The method of claim 16, wherein the step of removing the first portion of liquid from the slurry comprises:
placing the slurry in contact with a liquid-permeable membrane;
applying a negative pressure gradient across the liquid-permeable membrane; and
driving the first portion of liquid through the liquid-permeable membrane using the negative pressure gradient.

19. The method of claim 16, wherein building the filter body comprises:
placing the slurry into a mold having one or more orifices arranged at at least one end of the mold; and
applying a compressive load to the slurry in order to drive the second portion of the liquid from the slurry through the one or more orifices.

20. The method of claim 19, wherein the filter body has a height dimension and wherein applying the compressive load compresses the slurry to the height dimension.

21. The method of claim 1, wherein the step of curing the filter body using heat comprises fusing individual strands of the at least one fiber material together.

22. The method of claim 21, wherein the step of curing the filter body using heat comprises heating the filter body to a temperature that is near, but below, a melting temperature of the at least one fiber material.

23. The method of claim 1, wherein the liquid is water.
